(19) United States
(12) Patent Application Publication
(10) Pub. No.: US 2018/0361630 A1
(43) Pub. Date: Dec. 20, 2018

(54) HOUSING INCLUDING PATTERNED-STRUCTURE LAYER AND METHOD THEREOF

(71) Applicant: SAMSUNG ELECTRONICS CO., LTD., Suwon-si (KR)

(72) Inventors: Min KIM, Gwacheon-si (KR); Yongha KIM, Suwon-si (KR); Hyun-Hee LEE, Suwon-si (KR); Minhyouk KIM, Seongnam-si (KR); Seon-Jung KIM, Daegu (KR); Yuguen KIM, Yongin-si (KR); Hakju KIM, Gumi-si (KR); Seon KIM, Suwon-si (KR); Kyungtae BYUN, Seoul (KR)

(21) Appl. No.: 15/959,570

(22) Filed: Apr. 23, 2018

(30) Foreign Application Priority Data
Jun. 20, 2017 (KR) 10-2017-0077955

(51) Int. Cl. B29C 43/02; B29C 43/52; B29C 35/08

(52) U.S. Cl. CPC B29C 43/021; B29C 43/52; B29L 2031/3437; B29C 2043/023; B29C 2035/0827; B29C 35/0805

(57) ABSTRACT

According to various embodiments, there may be provided a housing manufacturing method including preparing a base material, disposing at least one patterned structure layer including a plurality of fillers on an upper portion of the base material, and disposing a protective layer on an upper portion of the patterned structure layer. In addition, the housing manufactured by the aforementioned manufacturing method may be applied to at least part of an exterior of an electronic device.

### CROSS REFERENCE TO RELATED APPLICATION

This application is based on and claims priority under 35 U.S.C. § 119 to Korean Patent Application No. 10-2017-0077955, filed on Jun. 20, 2017, in the Korean Intellectual Property Office, the disclosure of which is incorporated by reference herein in its entirety.

### BACKGROUND

### Field

The disclosure relates to a housing including a patterned structure layer, and a manufacturing method thereof.

### Description of Related Art

A housing (e.g., a film, glass, metal, or double injection of metal and resin) which constitutes an exterior of various constructions including electronic devices may be coated to an upper side of a base material through various techniques. Recently, in order to improve aesthetics of products and to emphasize a differentiation for each product, there is competition to add new colors, textures, or the like in various manners as well as coating.

In order to emphasize a product-specific differentiation and to enhance aesthetics, a housing (e.g., a film, glass, metal, or double injection of metal and resin) which constitutes an exterior of various constructions may be produced by forming a deposition layer on an upper side of a base material and by processing and finishing at least one coating film on an upper portion of the deposition layer. For example, the housing may be manufacture using a method which performs coating and printing, followed by curing, by compounding and diluting resin such as a main material, a hardener, or a thinner to use a paint- or dye-specific color and density and a method which primarily uses metal deposition using a metal-specific color and a high reflectance feature and optical deposition based on a multi-layered structure of materials having different refractive indices. In particular, a color adjustment scheme of such a coating technique controls a thickness of a coating film and a deposition layer.

However, a color realization technique uses an inherent color, transmittance/reflectance, and refractive index of each material, and colors and perception of the colors are expressed in a limited range. Thus, when it is intended to add and adjust a differentiated effect such as depth and three-dimensional perception with respect to the existing colors, it may be difficult to realize new textures and color additions through the conventional methods. In addition, in order to realize and change a partial color effect, it is necessary to perform partial coating through a precise masking operation or to utilize an etching technique after the entire coating process, which leads to low productivity depending on an increase in a manufacturing cost.

### SUMMARY

According to various embodiments of the present disclosure, there may be provided a housing including a patterned structure layer, and a manufacturing method thereof.

According to various embodiments, there may be provided a housing including a patterned structure layer capable of providing a differentiated color distinguished from the existing color, and a manufacturing method thereof.

According to various embodiments, there may be provided a housing including a patterned structure layer that facilitates productivity improvement and manufacturing cost reduction by simplifying a manufacturing process while realizing a differentiated color, and a manufacturing method thereof.

According to various embodiments, there may be provided a housing manufacturing method including preparing a base material, forming at least one patterned structure layer including a plurality of fillers on an upper portion of the base material, and forming a protective layer on an upper portion of the patterned structure layer. In addition, the housing manufactured by the aforementioned manufacturing method may be applied to at least part of an exterior of an electronic device.

According to various embodiments, there may be provided a housing including a base material, at least one patterned structure layer including a plurality of fillers laminated on an upper portion of the base material, and a protective layer laminated on an upper portion of the patterned structure layer.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A and FIG. 1B are front and rear perspective views of an electronic device including a housing according to various embodiments of the present disclosure;

FIG. 2 is a flowchart illustrating a manufacturing process of a housing according to various embodiments of the present disclosure;

FIGS. 3A, 3B, 3C, 3D, 3E and FIG. 3F are diagrams illustrating a procedure for manufacturing a housing according to various embodiments of the present disclosure;

FIG. 4 is a cross-sectional view of a housing according to various embodiments of the present disclosure;

FIG. 5 includes photographs illustrating various structures of a patterned structure layer according to various embodiments of the present disclosure;

FIGS. 6A, 6B, 6C and FIG. 6D are diagrams illustrating a structure of a patterned structure layer according to various embodiments of the present disclosure; and

FIG. 7 is a diagram illustrating a configuration of a patterned structure layer applied to a curved housing according to various embodiments of the present disclosure.

### DETAILED DESCRIPTION

Hereinafter, various example embodiments of the present disclosure are described with reference to the accompanying drawings. While the various embodiments of the present disclosure are susceptible to various modifications and alternative forms, a specific embodiment thereof has been illustrated by way of example in the drawings and will herein be described in greater detail. It should be understood, however, that it is not intended to limit the various embodiments of the present disclosure to the particular form disclosed, but, on the other hand, the various embodiments of the present disclosure are to cover all modifications, equivalents, and alternatives falling within the spirit and scope of the various embodiments of the present disclosure as defined by the appended claims. Like reference numerals denote like components throughout the drawings.

The expression “include” or “may include” used in the various embodiments of the present disclosure is intended to indicate a presence of a corresponding function, operation, or component disclosed herein, and it is not intended to limit a presence of one or more functions, operations, or components. In addition, in the various embodiments of the present disclosure, the term “include” or “have” is intended to indicate that characteristics, numbers, steps, operations, components, and elements disclosed in the specification or combinations thereof exist. As such, the term “include” or “have” should be understood that there are additional possibilities of one or more other characteristics, numbers, steps, operations, components, elements or combinations thereof.

In various embodiments of the present disclosure, an expression “or” includes any and all combinations of words enumerated together. For example, “A or B” may include A or B, or may include both of A and B.

Although expressions used in various embodiments of the present disclosure such as “1^{st}”, “2^{nd}”, “first”, “second” may be used to express various components of the various embodiments, it is not intended to limit the corresponding components. For example, the above expressions are not intended to limit an order or an importance of the corresponding components. The above expressions may be used to distinguish one component from another component. For example, a 1^{st} user device and the 2^{nd} user device are both user devices, and indicate different user devices. For example, a 1^{st} component may be termed a 2^{nd} component, and similarly, the 2^{nd} component may be termed the 1^{st} component without departing from the scope of the various embodiments of the present disclosure.

When a component is mentioned as being “connected” to or “accessing” another component, this may refer, for example, to a situation in which it is directly connected to or accessing the other component, but it is to be understood that there are no intervening components present. On the other hand, when a component is mentioned as being “directly connected” to or “directly accessing” another component, it is to be understood that there are no intervening components present.

The terminology used in various embodiments of the present disclosure is for the purpose of describing particular embodiments only and is not intended to limit the various embodiments of the present disclosure. A singular expression includes a plural expression unless there is a contextually distinctive difference therebetween.

Unless otherwise defined, all terms (including technical and scientific terms) used herein have the same meaning as commonly understood by those ordinarily skilled in the art to which various embodiments of the present disclosure belong. It will be further understood that terms, such as those defined in commonly used dictionaries, should be interpreted as having a meaning that is consistent with their meaning in the context of the relevant art and the various embodiments of the present disclosure, and will not be interpreted in an idealized or overly formal sense unless expressly so defined herein.

A housing according to various embodiments of the present disclosure may include a housing which is applied as an exterior of not only an electronic device but also a normal construction or a housing applied alone. In addition, although the housing applied to the electronic device is illustrated and described as an example in example embodiments of the present disclosure, the housing is not limited thereto. For example, the housing may include a patterned structure layer according to various example embodiments of the present disclosure, and may include, for example, and without limitation, a film, glass, metal, or double injection of metal and resin, or the like, which is used as an exterior of a construction or used alone.

According to various embodiments, an electronic device to which a housing constructed according to an example embodiment of the present disclosure is applied may be a device including a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a MPEG-1 Audio Layer 3 (MP3) player, a mobile medical device, a camera, and a wearable device (e.g., a Head-Mounted-Device (HMD) such as electronic glasses, electronic clothes, an electronic bracelet, an electronic necklace, an electronic appcessory, an electronic tattoo, or a smart watch), or the like, but is not limited thereto.

According to some embodiments, the electronic device may be a smart home appliance having a communication function. For example, the smart home appliance may include at least one of a TeleVision (TV), a Digital Video Disk (DVD) player, an audio, a refrigerator, an air conditioner, a cleaner, an oven, a microwave oven, a washing machine, an air purifier, a set-top box, a TV box (e.g., Samsung HomeSync™, Apple TV™, or Google TV™), a game console, an electronic dictionary, an electronic key, a camcorder, and an electronic picture frame, or the like, but is not limited thereto.

According to some embodiments, the electronic device may include at least one of various medical devices (e.g., Magnetic Resonance Angiography (MRA), Magnetic Resonance Imaging (MRI), Computed Tomography (CT), imaging equipment, ultrasonic instrument, etc.), a navigation device, a Global Positioning System (GPS) receiver, an Event Data Recorder (EDR), a Flight Data Recorder (FDR), a car infotainment device, an electronic equipment for ship (e.g., a vessel navigation device, a gyro compass, etc.), avionics, a security device, a car head unit, an industrial or domestic robot, an Automatic Teller's Machine (ATM) of financial institutions, and Point Of Sales (POS) of shops, or the like, but is not limited thereto.

According to some embodiments, the electronic device may include at least one of a furniture or a part of building/constructions including a communication function, an electronic board, an electronic signature input device, a projector, and various measurement machines (e.g., water supply, electricity, gas, propagation measurement machine, etc.), or the like, but is not limited thereto. The electronic device according to various embodiments of the present disclosure may be one or more combinations of the aforementioned various devices. In addition, the electronic device according to various embodiments of the present disclosure may be a flexible device. In addition, it is apparent those ordinarily skilled in the art that the electronic device according to the various embodiments of the present disclosure is not limited to the aforementioned devices.

Hereinafter, an electronic device according to various embodiments will be described with reference to the accompanying drawings. The term ‘user’ used in the various embodiments may refer to a person who uses the electronic device or a device which uses the electronic device (e.g., an Artificial Intelligence (AI) electronic device).

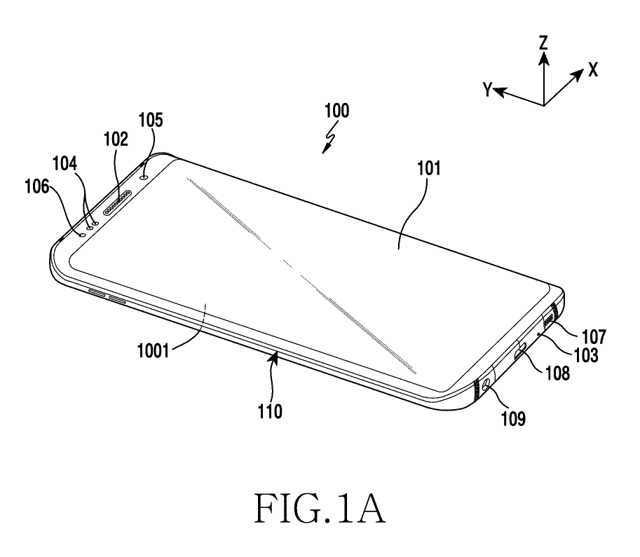

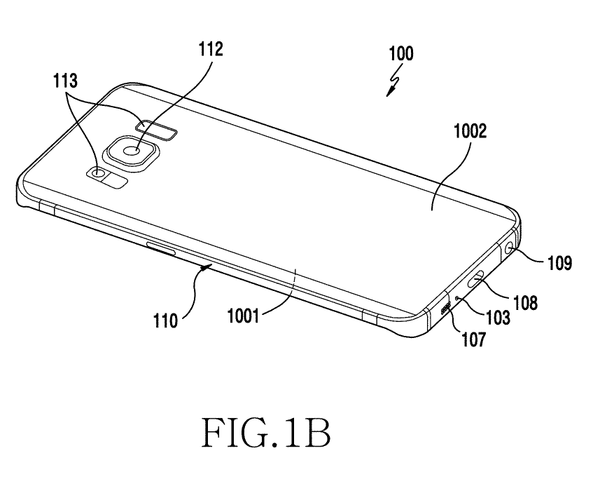

FIG. 1A and FIG. 1B are front and rear perspective views of an electronic device including a housing according to various embodiments of the present disclosure.

Referring to FIG. 1A and FIG. 1B, an electronic device 100 may include a housing 110. According to an embodiment, the housing 110 may include a conductive member and a non-conductive member. However, without being limited thereto, the housing 110 may include a conductive member and a non-conductive member that are double injected together. According to an embodiment, the electronic device 100 may include a display 101 (e.g., a touch screen display) disposed to a first side 1001 (e.g., a front side or an upper side) facing a first direction (e.g., a Z-axis direction). According to an embodiment, the electronic device 100 may include a receiver 102 disposed to at least part of the housing 110 to output a voice of a peer user. According to an embodiment, the electronic device 100 may include a microphone device 103 disposed to the housing 110 to transmit a voice of a user to the peer user. According to an embodiment, the electronic device 100 may include at least one key input device disposed on the housing 110. According to an embodiment, the key input device may include at least one side key button disposed to a lateral side of the housing 110. According to an embodiment, the at least one side key button may include a volume control button, a wake-up button, or a button for performing a specific function (e.g., a function for executing artificial intelligence, a function of entering a fast speech recognition execution mode, or the like).

According to various embodiments, the electronic device 100 may include components for performing various functions of the electronic device 100. The components may be exposed to the display 101 or may perform a function through a window by being disposed not to be exposed. According to an embodiment, the components may include at least one sensor module 104. The sensor module 104 may include, for example, and without limitation, an illumination sensor (e.g., an optical sensor), a proximity sensor (e.g., an optical sensor), an infrared sensor, an ultrasonic sensor, a fingerprint sensor, a face recognition sensor, and/or an iris recognition sensor, or the like. According to an embodiment, the component may include a camera device 105. According to an embodiment, the component may include an indicator 106 (e.g., an LED device) for visually presenting status information of the electronic device to the user. According to an embodiment, at least one of these components may be disposed to be exposed through at least some regions of a second side 1002 (e.g., a back side or a rear side) facing a second direction (e.g., −Z-axis direction) opposite to a first direction of the electronic device 100.

According to various embodiments, the electronic device 100 may include a speaker device 107. According to an embodiment, the electronic device 100 may include an interface connector port 108 for charging the electronic device 100 using a data transmission/reception function and external power provided by an external device. According to an embodiment, the electronic device 100 may include an ear jack assembly 109.

According to various embodiments, the electronic device 100 may include a rear camera device 112 disposed to the second side 1002 and at least one electronic component 113 disposed in the vicinity of the rear camera device 112. According to an embodiment, the electronic component 113 may include, for example, and without limitation, at least one of an illumination sensor (e.g., an optical sensor), a proximity sensor (e.g., an optical sensor), an infrared sensor, an ultrasonic sensor, a heartrate sensor, a fingerprint recognition sensor, and/or a flash device, or the like.

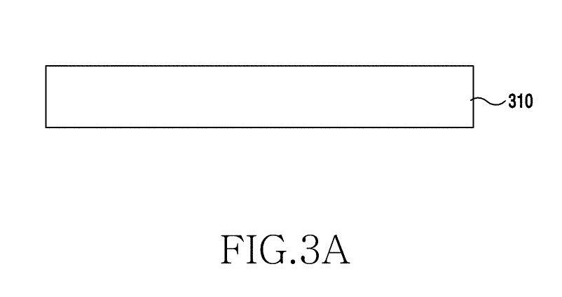

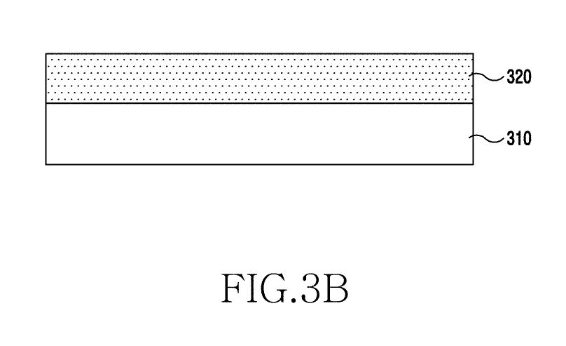

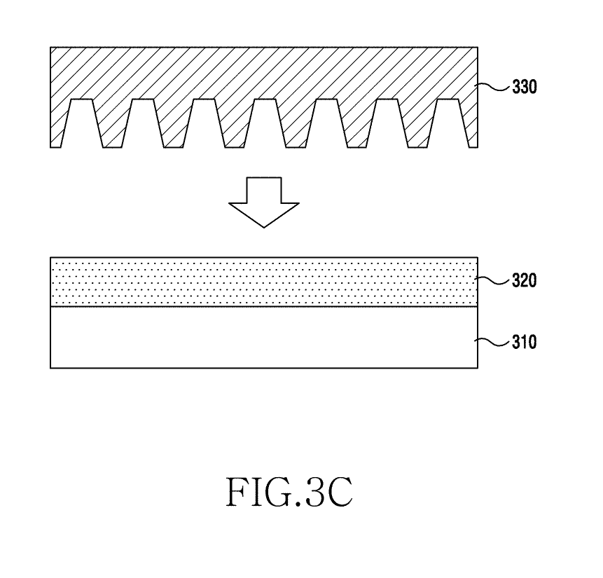

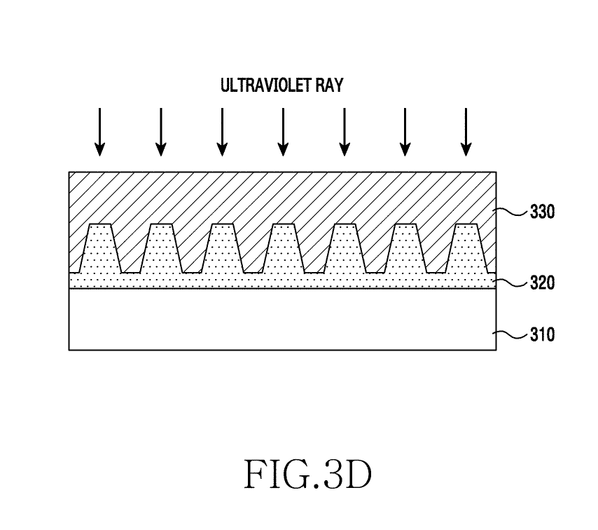

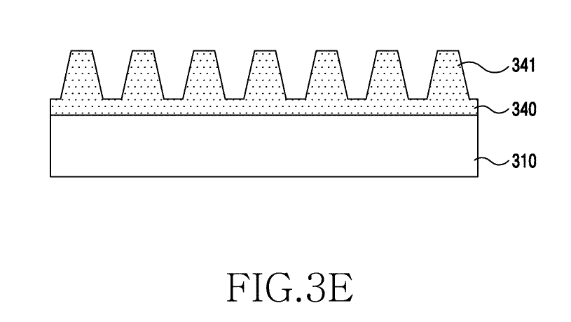

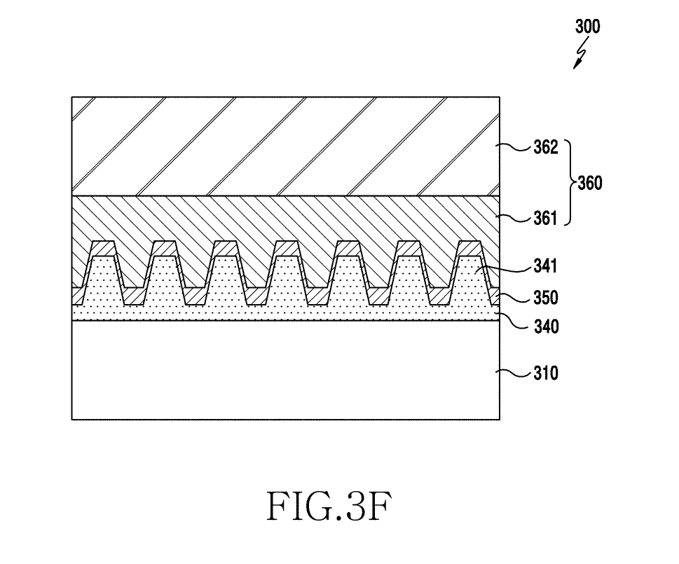

According to various embodiments, the housing 110 may include a lateral side and second side which are applied as an exterior of the electronic device 100. According to an embodiment, the lateral side and the second side may be formed integrally. According to an embodiment, an outer side of the housing 110 may include a patterned structure layer (e.g., the patterned structure layer 340 of FIG. 3F) according to an example embodiment of the present disclosure. According to an embodiment, the patterned structure layer (e.g., the patterned structure layer 340 of FIG. 3F) may include a nano-scale pattern, and may express various colors differentiated from the conventional one due to cyclic or non-cyclic and identical or different shapes. According to an embodiment, the housing 110 may have a new effect such as an increase/decrease in brightness, a change in colors and textures (color variation, ceramic-like), or the like in comparison with the conventional elements for expressing colors and textures due to a characteristic of the patterned structure layer (transmittance/reflectance or the like based on a viewing angle).

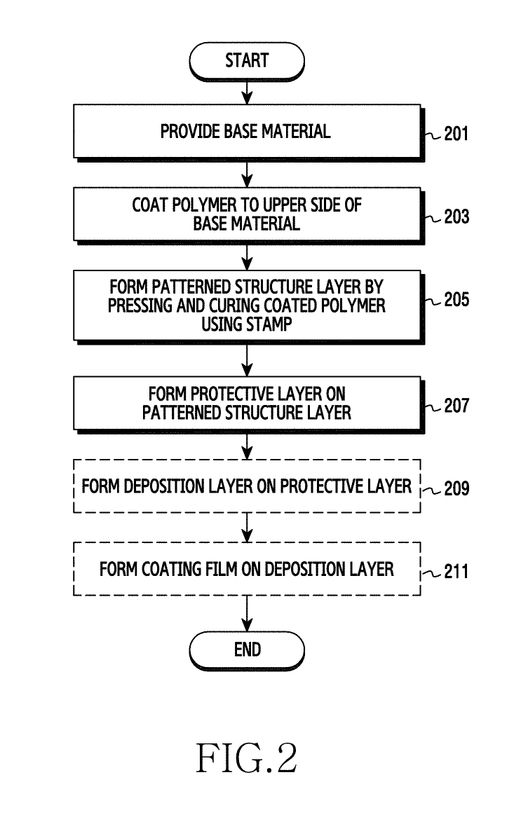

FIG. 2 is a flowchart illustrating a manufacturing process of a housing according to various embodiments of the present disclosure. FIGS. 3A, 3B, 3C, 3D, 3E and FIG. 3F are diagrams illustrating a procedure for manufacturing a housing according to various embodiments of the present disclosure.

A housing 300 of FIG. 3F may be at least partially similar to the housing 110 of FIG. 1, or may include other embodiments of the housing. The manufacturing process of FIG. 2 will be described with reference to FIGS. 3A, 3B, 3C, 3D, 3E and FIG. 3F.

Referring to FIG. 2, in operation 201, a base material 310 may be provided as shown in FIG. 3A. According to an embodiment, the base material 310 may include, for example, and without limitation, at least one member of synthetic resin, glass, film, metal, and composite materials, or the like. According to an embodiment, when the base material 310 is made of a metal material, it can be formed through casting, press working, or the like. According to an embodiment, when the base material 310 is made of a synthetic resin material, it may be formed through injection. According to an embodiment, when the base material is made of a dissimilar material of synthetic resin and metal, it may be formed through double injection.

Thereafter, in operation 203, as illustrated in FIG. 3B, a polymer 320 may be coated to an upper side of the base material 310 to form a patterned structure layer (e.g., the patterned structure layer 340 of FIG. 3E) through, for example, and without limitation, nano-imprinting. According to an embodiment, the polymer 320 (e.g., resin) may include, for example, and without limitation, a thermosetting or ultraviolet-curable material. According to an embodiment, the polymer 320 may be coated on the base material 310 in a typical spray or spin coating manner. According to an embodiment, the housing 300 may be configured such that different colors are expressed by applying polymers having different refractive indices even if the same pattern is applied.

Thereafter, in operation 205, as illustrated in FIG. 3C, the coated polymer 320 may be pressed with predetermined pressure using a stamp 330 (e.g., a die, a mold, etc.), and thereafter may be cured to form the patterned structure layer (e.g., the patterned structure layer 340 of FIG. 3E). According to an embodiment, the stamp 330 may be formed of a nano-construction corresponding to the patterned structure layer 340, for example, through electron beam lithography processing. According to an embodiment, the nano-construction may be processed in an embossed and/or engraved manner. According to an embodiment, the stamp 330 may be formed of a quartz material to facilitate transmission of an ultraviolet ray irradiated after the polymer 320 is pressed. As illustrated in FIG. 3D, the polymer 320 pressed by the stamp 33 may be cured after a specific period of time elapses by the irradiated ultraviolet ray. According to FIG. 3E, the stamp 330 may be separated from the cured polymer 320 by the ultraviolet ray, and a patterned structure layer 340 including a plurality of fillers 341 comprising a pattern may be formed on an upper portion of the base material 310. According to an embodiment, the filler 341 may be formed in a cyclic structure manner with a specific cycle. According to an embodiment, the fillers 341 may have different cycles.

Thereafter, in operation 207, a protective layer may be formed on an upper portion of the patterned structure layer 340 to protect a pattern of a patterned construction formed with an ultrafine size.

Thereafter, in operation 209, as illustrated in FIG. 3F, at least one deposition layer 350 may be formed on an upper portion of the protective layer. According to an embodiment, the protective layer may be omitted and the deposition layer 350 may be laminated on an upper portion of the patterned structure layer 340. According to an embodiment, a primer layer may be further formed so that a deposition material can be uniformly and smoothly coated and adhered to a surface of the patterned structure layer before the deposition layer 350 is formed. According to an embodiment, the primer layer may be formed as a single layer or a multi-layer, and may be formed by coating with a UV or urethane curing type coating material in accordance with curing with resin of acryl, olefin, urethane type, or other types. According to an embodiment, the primer layer may be cured through a process such as oven or natural drying or through ultraviolet curing.

According to various embodiments, the deposition layer 350 may be formed as a single layer or a multi-layer. According to an embodiment, the deposition layer 350 may use, for example, and without limitation, at least one of the following types of materials: Sn-type, Ti-type, Cr-type, and Al-type, or the like. According to an embodiment, the deposition layer 350 may include at least one of TiO2, TiN, TiCN, and SiO2. According to an embodiment, the deposition layer 350 may include at least one of a silicon oxide film (SiO2), a titanium oxide film (TiO2), an aluminum oxide film (Al₂O₃), a zirconium oxide film (ZrO2), and a tantalum oxide film (Ta2O5).

According to various embodiments, deposition materials having different refractive indices may be applied when the deposition layer 350 is formed as the multi-layer. According to an embodiment, at least two types of deposition materials may be mixed to form a first deposition material which exhibits a desired first refractive index and a second deposition material which exhibits a desired second refractive index having a different refractive index from the first refractive index, and the two deposition materials may be alternately deposited to form the deposition layer 350. For example, a refractive index of the silicon oxide film (SiO2) is 1.4, a refractive index of the titanium oxide film (TiO2) is 2.4, and a refractive index of the aluminum oxide film (Al₂O₃) is 1.7. Therefore, the silicon oxide film (SiO2) and the titanium oxide film (TiO2) which have a large refractive index difference may be alternately deposited and the patterned structure layer may be used, thereby being advantageously applied to a ceramic pearl texture effect and anisotropic color reproduction.

Thereafter, in operation 211, a coating film 360 (e.g., coating and/or printing) may be formed on an upper portion of the deposition layer 350. According to an embodiment, the coating film 360 may include a basic color coating film 361 including at least one layer coated to an upper portion of the deposition layer 350 and a transparent film 362 coated to an upper portion thereto. According to an embodiment, the transparent film 362 may use a transparent urethane paint in an injection fashion to protect the basic color coating film 361. According to an embodiment, a print layer may be formed together with the coating film, or the print layer may be formed by excluding the coating film. According to an embodiment, the print layer may be formed through at least one of Direct Digital Printing (DDP), gravure printing, thermal transfer printing, water transfer printing, pad printing, and silk printing.

According to various embodiments, since a differentiated desired color can be realized by a transmittance/reflectance of a patterned structure of the patterned structure layer 340 formed on the upper portion of the base material 310, the aforementioned deposition layer 350 and coating film 360 may not be necessarily constructed.

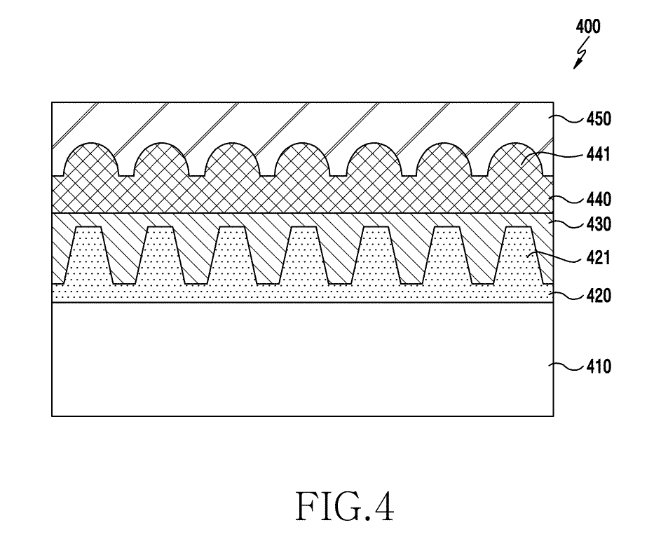

FIG. 4 is a cross-sectional view of a housing according to various embodiments of the present disclosure.

A housing 400 of FIG. 4 may be at least partially similar to the housing 110 of FIG. 1, or may include other embodiments of the housing.

According to various embodiments, patterned structure layers 420 and 440 applied to an upper portion of the base material 410 may be formed in a multi-layer. According to an embodiment, the patterned structure layers 420 and 440 may include a first patterned structure layer 420 disposed on the upper portion of the base material 410 and a second patterned structure layer 420 disposed on an upper portion of the first patterned structure layer 420. According to an embodiment, each of the patterned structure layers 420 and 440 may include protective layers 430 and 450 disposed on upper portions thereof.

According to various embodiments, the first patterned structure layer 420 and the second patterned structure layer 440 may be formed of a polymer having the same refraction index or a polymer having a different refraction index. According to an embodiment, a pattern of the first patterned structure layer 420 and a pattern of the second patterned structure layer 440 may exhibit different refraction indices due to different shapes, cycles, depths, slopes, or step heights of the fillers 421 and 441 formed respectively thereon. According to an embodiment, the housing 400 may further adjust colors expressed by laminating the plurality of patterned structure layers 420 and 440.

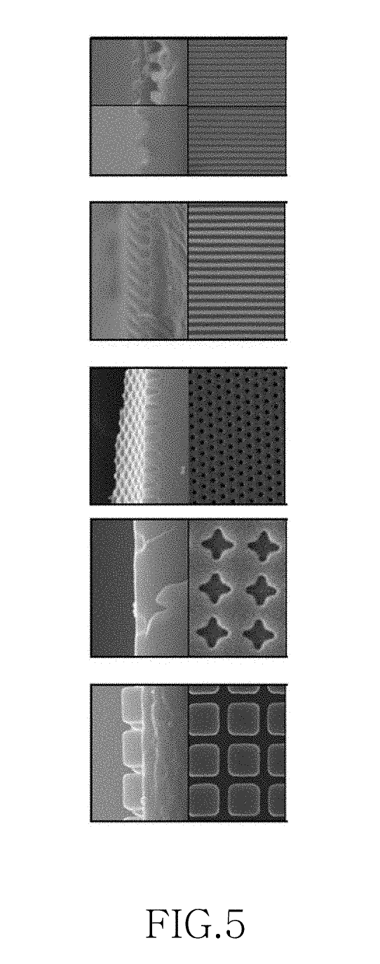

FIG. 5 includes photographs illustrating various structures of a patterned structure layer according to various embodiments of the present disclosure. A plurality of fillers of a patterned structure layer may be formed in a rectangular shape, cross shape, or dot shape formed regularly or irregularly or may be formed in a line shape having a regular or irregular interval and width.

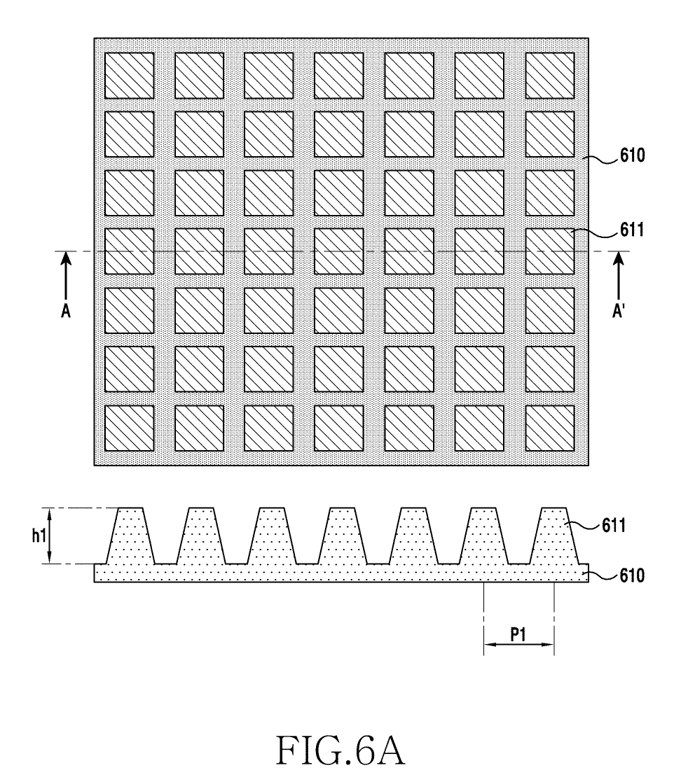

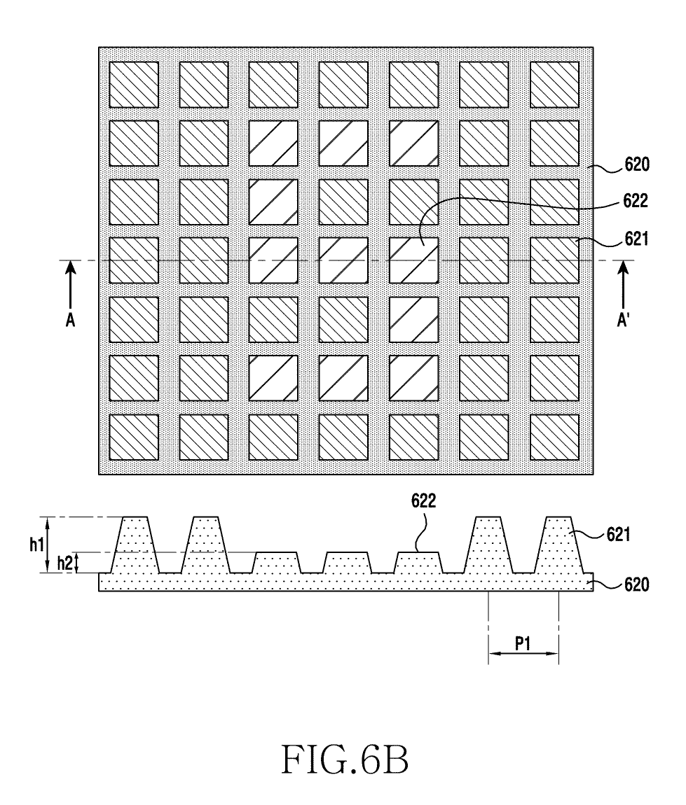

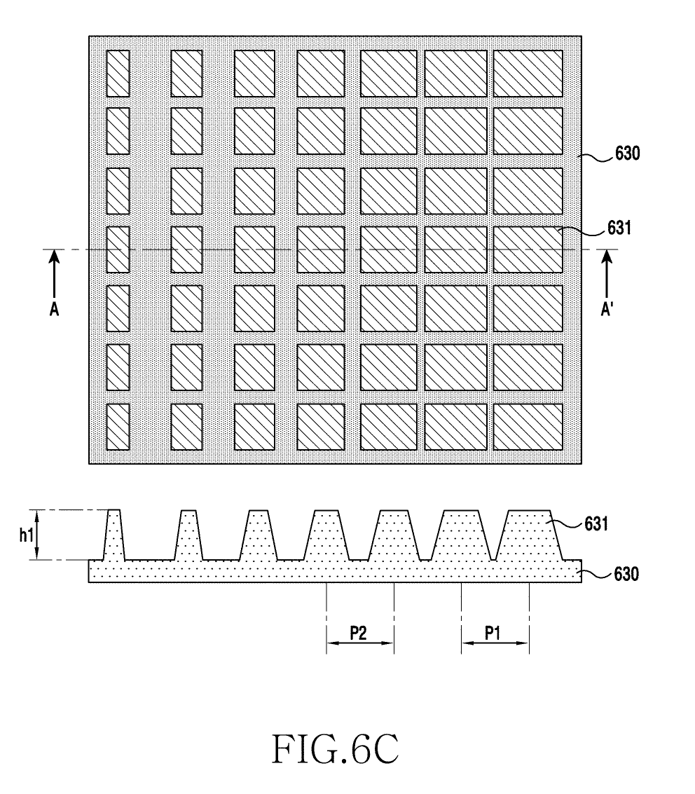

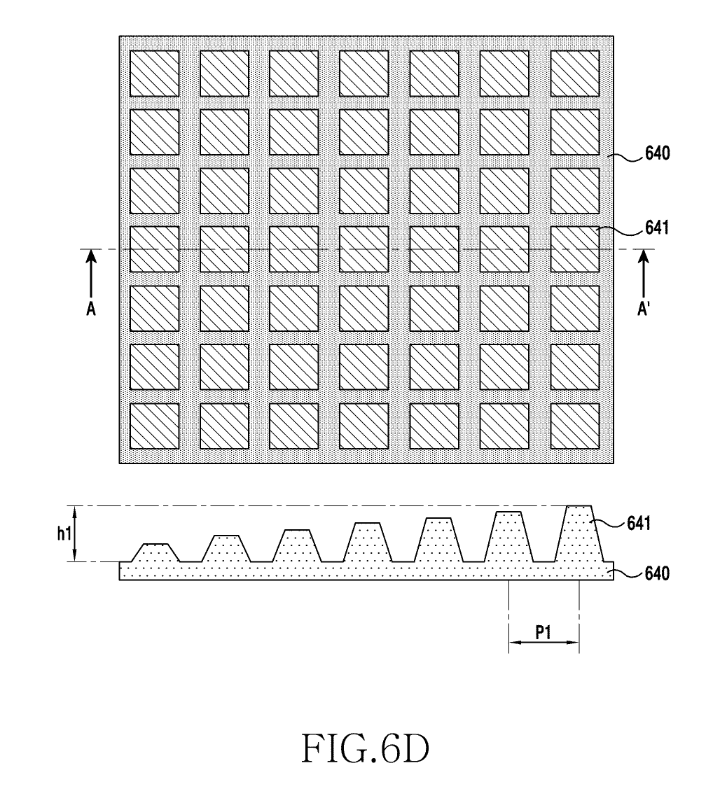

FIGS. 6A, 6B, 6C and FIG. 6D are diagrams illustrating a structure of a patterned structure layer according to various embodiments of the present disclosure. FIGS. 6A, 6B, 6C and FIG. 6D are plan views of a patterned layer structure and cross-sectional views taken along the line A-A′.

Patterned structure layers 610, 620, 630, and 640 of FIGS. 6A, 6B, 6C and FIG. 6D may be at least partially similar to the patterned structure layer 340 of FIG. 3F or the patterned structure layers 420 and 440 of FIG. 4, or may include other embodiments of the patterned structure layer.

Referring to FIG. 6A, the patterned structure layer 610 may include a plurality of fillers 611. According to an embodiment, the fillers 611 may be cyclically disposed with a specific interval. According to an embodiment, each of the filler 611 may have the same shape and may be disposed to have the same cycle p1 and the same depth h1.

Referring to FIG. 6B, the patterned structure layer 620 may include a plurality of fillers 621 and 622. According to an embodiment, the fillers 621 may be disposed with an interval. According to an embodiment, each of the fillers 621 and 622 has the same cycle p1, but the fillers 621 and 622 having different depths h1, h2, . . . may be disposed at specific positions. According to an embodiment, different colors may be realized when viewed in the same direction due to different refractive indices and/or transmittances exhibited for regions different from each other depending on a structure of disposing the fillers 621 and 622 having different depths. These embodiments may be used to emphasize a logo of the product or may be used for a decorating purpose or the like.

Referring to FIG. 6C, the patterned structure layer 630 may include a plurality of fillers 631. According to an embodiment, the fillers 631 have the same depth, but may be disposed not-cyclically to have different shapes and different cycles p1, p2, . . . . According to an embodiment, different colors may be realized when viewed in the same direction due to different refractive indices and/or transmittances exhibited for regions different from each other depending on a structure of disposing the fillers 631 having different shape and cycles.

Referring to FIG. 6D, the patterned structure layer 640 may include a plurality of fillers 641. According to an embodiment, the fillers 641 have the same cycle p1 with a specific interval, but may be disposed to have different depths. According to an embodiment, as shown in the figure, the filler has a depth which is gradually increased as it progresses in one direction. However, without being limited thereto, the depth may be gradually increased or decreased as it progresses in the other direction. In addition, the fillers 641 may have a depth which is increased or decreased when it is spaced apart from a specific region. According to an embodiment, different colors (gradation effect) may be realized when viewed in the same direction due to different refractive indices and/or transmittances exhibited for regions different from each other depending on a structure of gradually disposing the fillers 630 having different depths. According to an embodiment, although not shown, the example patterned structure layer of the present disclosure may be formed to include fillers in which at least one of different features of the aforementioned patterned structure layers 610, 620, 630, and 640 are mixed.

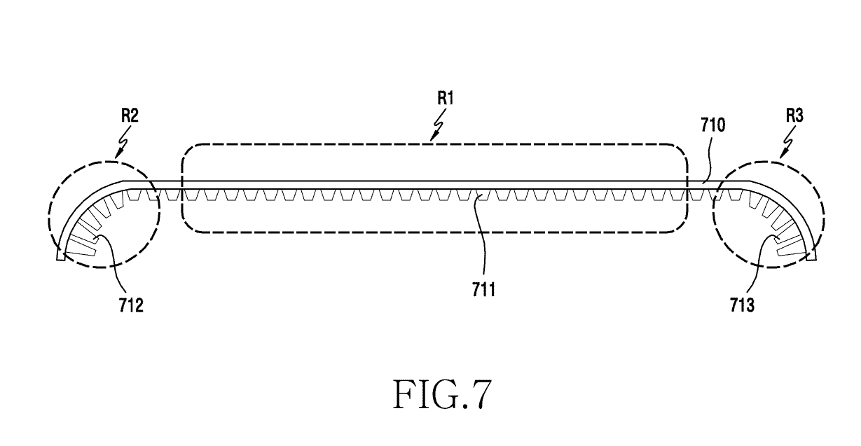

FIG. 7 is a diagram illustrating a configuration of a patterned structure layer applied to a curved housing according to various embodiments of the present disclosure.

The patterned structure layer of FIG. 7 may be similar to the patterned structure layer 340 of FIG. 3F, the patterned structure layers 420 and 440 of FIG. 4, or the patterned structure layers 610, 620, 630, and 640 of FIGS. 6A, 6B, 6C and FIG. 6D, or may include other embodiments of the patterned structure layer.

Referring to FIG. 7, a patterned structure layer 710 may be realized to emphasize a corresponding region of the housing by using different features (e.g., different cycles, different step heights, progressive step height changes, or the like) of the fillers 711, 712, 713 depending on a shape of the housing to be applied. For example, as illustrated, a region R1 is a straight section, and regions R2 and the region R3 are curved sections, and it may be adjusted such that different colors are expressed in the respective regions R1, R2, and R3 by using at least one of the aforementioned features of filler 711 disposed to the region R1 and the fillers 712 and 713 disposed respectively to the regions R2 and R3. A color expressed differently for each of the regions may be applied to a flat surface and curved surface (edge effect) of a product having a 3D shape.

Various embodiments of the present disclosure may apply the configuration of the patterned structure layer in various manners to provide differentiated aesthetics to a user by providing a housing in which colors differentiated from the existing colors are expressed. In addition, since differentiated colors can be realized on the housing using relatively simple processing, productivity can be improved and a manufacturing cost can be reduced.

According to various example embodiments, there may be provided a housing manufacturing method including preparing a base material, forming at least one patterned structure layer including a plurality of fillers on an upper portion of the base material, and forming a protective layer on an upper portion of the patterned structure layer. In addition, the housing manufactured by the aforementioned manufacturing method may be applied to at least part of an exterior of an electronic device.

According to various example embodiments, the forming of the patterned structure layer may include, for example, and without limitation, coating a thermosetting or ultraviolet-curable polymer, or the like to an upper portion of the base material, pressing the coated polymer with a stamp having a nano-construction formed thereon, heating or irradiating ultraviolet rays in a state where the stamp is pressed, and removing the stamp.

According to various example embodiments, the plurality of fillers may be formed with the same period, depth, and shape.

According to various example embodiments, the plurality of fillers may be formed with different shapes, different periods, or different depths for respective regions, and different colors may be expressed by a different reflectance and/or transmittance of light.

According to various example embodiments, the plurality of fillers may be formed to have a step height which is gradually increased or decreased with respect to a specific region.

According to various example embodiments, the patterned structure layer may be laminated with at least two layers, and each patterned structure layer may include a plurality of fillers formed with different shapes, different periods, or different depths.

According to various example embodiments, the housing may include at least one of synthetic resin, glass, film, metal, and composite material.

According to various example embodiments, the housing may include a curved region. The filler of the patterned structure layer disposed to each of the curved region and another region other than the curved region may be formed to have different shapes, different cycles, or different depths.

According to various example embodiments, the housing may be applied to at least part of an outer side of the electronic device for communication.

According to various example embodiments, the housing may further include at least one deposition layer disposed to an upper portion of the protective layer or replaced with the protective layer.

According to various example embodiments, the at least one deposition layer may be formed of a material including, for example, and without limitation, at least one of Sn-type, Ti-type, Cr-type, and Al-type materials, or the like.

According to various example embodiments, the at least one deposition layer may be laminated with two or more layers, and each deposition layer may be formed of a material having a different refractive index.

According to various example embodiments, the housing may further include at least one coating film and/or print layer laminated on an upper portion of the protective layer.

According to various example embodiments, the coating film may include at least one basic color coating film and a transparent film coated to an upper portion thereof.

According to various example embodiments, the print layer may be formed through at least one of Direct Digital Printing (DDP), gravure printing, thermal transfer printing, water transfer printing, pad printing, and silk printing.

According to various example embodiments, there may be provided a housing including a base material, at least one patterned structure layer including a plurality of fillers laminated on an upper portion of the base material, and a protective layer laminated on an upper portion of the patterned structure layer.

Various example embodiments of the present disclosure disclosed herein and the drawings are merely examples presented for clarity and are not intended to limit the scope of the present disclosure. Therefore, in addition to the embodiments disclosed herein, various changes in forms and details made without departing from the technical concept of the present disclosure will be understood as being included in the scope of the present disclosure.

What is claimed is:

1. A housing comprising:
a base material;
at least one patterned structure layer comprising a plurality of fillers disposed on an upper portion of the base material; and
a protective layer disposed on an upper portion of the patterned structure layer.

2. The housing of claim 1, wherein the plurality of fillers have a same period, depth, and shape.

3. The housing of claim 1, wherein the plurality of fillers have different shapes, different periods, and/or different depths for different regions, and different colors are expressed by a different reflectance and/or transmittance of light.

4. The housing of claim 1, wherein the patterned structure layer comprises at least two layers, and each of the at least two layers comprises a plurality of fillers having different shapes, different periods, and/or different depths.

5. The housing of claim 1, wherein the plurality of fillers have a step height which is gradually increased or decreased in a specific region.

6. The housing of claim 1, wherein the housing comprises at least one of: synthetic resin, glass, film, metal, and composite material.

7. The housing of claim 1,
wherein the housing comprises a curved region, and
wherein the filler of the patterned structure layer disposed on each curved region and another region other than the curved region has different shapes, different cycles, and/or different depths.

8. The housing of claim 1, wherein the housing is applied to at least part of an outer side of an electronic device for communication.

9. The housing of claim 1, further comprising at least one deposition layer disposed on an upper portion of the protective layer and/or replaces the protective layer.

10. The housing of claim 9, wherein the at least one deposition layer is a material including at least one of: Sn-type, Ti-type, Cr-type, and Al-type materials.

11. The housing of claim 9, wherein the at least one deposition layer is laminated with two or more layers, and each deposition layer comprises a material having a different refractive index.

12. The housing of claim 1, further comprising at least one coating film and/or print layer laminated on an upper portion of the protective layer.

13. The housing of claim 12, wherein the coating film comprises at least one basic color coating film and a transparent film coated on an upper portion thereof.

14. The housing of claim 12, wherein the print layer is printed through at least one of: Direct Digital Printing (DDP), gravure printing, thermal transfer printing, water transfer printing, pad printing, and silk printing.

15. An electronic device comprising:
a housing comprising a first side, a second side facing an opposite direction of the first side, and a lateral side surrounding a space between the first side and the second side; and
a display disposed to be visually exposed through at least some regions of the first side,
wherein the housing comprises:
a base material;
at least one patterned structure layer comprising a plurality of fillers laminated on an upper portion of the base material; and
a protective layer laminated on an upper portion of the patterned structure layer.

16. A method of manufacturing a housing, the method comprising:
preparing a base material;
disposing at least one patterned structure layer including a plurality of fillers on an upper portion of the base material; and
disposing a protective layer on an upper portion of the patterned structure layer.

17. The method of claim 16, wherein the disposing of the patterned structure layer comprises:
coating a thermosetting or ultraviolet-curable polymer on an upper portion of the base material;
pressing the coated polymer with a stamp having a nano-construction formed thereon;
heating or irradiating ultraviolet rays in a state where the stamp is pressed; and
removing the stamp.

18. The method of claim 16, wherein the plurality of fillers have a same period, depth, and shape.

19. The method of claim 16, wherein the plurality of fillers have different shapes, different periods, and/or different depths for different regions, and different colors are expressed by a different reflectance and/or transmittance of light.

20. The method of claim 16, wherein the plurality of fillers have a step height which is gradually increased or decreased in a specific region.
